(19) United States
(12) Patent Application Publication
(10) Pub. No.: US 2012/0201649 A1
(43) Pub. Date: Aug. 9, 2012

(54) METHODS AND SYSTEMS FOR PORTABLE TURNTABLES OR ROTATION PLATFORMS BUILT BY ASSEMBLY

(75) Inventors: Kangna Nelson SHEN, New York, NY (US); Osamu TAKAHASHI, Tokyo (JP)

(73) Assignee: KOZO KEIKAKU ENGINEERING INC., Tokyo (JP)

(21) Appl. No.: 13/348,423

(22) Filed: Jan. 11, 2012

Related U.S. Application Data
(60) Provisional application No. 61/431,620, filed on Jan. 11, 2011.

(51) Int. Cl. F16M 13/00; B23P 11/00

(52) U.S. Cl. 414/816; 108/139; 29/898.07

(57) ABSTRACT

Portable turntables or rotation platforms built by assembly enable rotation of vehicles and/or loads of significant size and/or weight. The portable turntables or rotation platforms are highly effective and efficient with respect to materials, construction and environmental impact.

### CROSS-REFERENCE

This application claims the benefit under 35 U.S.C. 119(e) of U.S. Provisional Patent Application No. 61/431,620, filed Jan. 11, 2011, the contents of which are hereby incorporated by reference in their entirety.

### DESCRIPTION

1. Technical Field

The present subject matter relates to portable turntables or rotation platforms built by assembly that enable rotation of vehicles and/or loads of significant size and/or weight.

2. Background/Summary

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present subject matter relates to portable turntables or rotation platforms built by assembly that enable rotation of vehicles and/or loads of significant size and/or weight, for example trucks hauling freight irrespective of length, height or weight of the trucks and/or freight.

In accordance with a first aspect, a method of building by assembly a portable turntable or rotation platform is provided, comprising laying a number of steel plates on a flat surface, laying a fulcrum and setting a table or platform thereon, and laying at least one set of ball-bearings about the fulcrum, wherein the steel plates are laid out in a grid and the ball-bearings are placed in the shape of two concentric circles.

In accordance with another aspect, a method of rotating vehicles and/or loads of significant size and/or weight is provided, comprising utilizing a number of steel plates laid on a flat surface.

In accordance with a further aspect, a portable turntable or rotation platform built by assembly is provided, comprising a number of steel plates on a flat surface.

By making adjustments to the placement of, or varying the size of component steel plates and ball-bearings, the portable turntable or rotation platform, (hereinafter “Mega Susan”) may be used for the rotation of trucks hauling freight that are extremely long and tall with considerable weight. Non-limiting examples of such freight could be steel pipes and heavy machinery. Further aspects of, and configuration of, the specific mechanism and configuration of rotation, and further details of the trucks or freight that can be used with the Mega Susan are essentially limitless, and may vary based on motivation and desired use.

In one potential scenario, the Mega Susan may be configured to rotate a tractor or several tractors connected to each other and pulling several trailers connected to each other. The several tractors or trailers connected to each other are capable of having on them a freight of steel pipes, girders, rods, etc. in length in excess of 100 meters (300 feet) or more. The Mega Susan used in this manner would far exceed the capacity of any device for rotation currently in existence in terms of unit cost and ease of production and use.

The Mega Susan presents numerous advantages. The cost of assembling together the Mega Susan of a desired length and width is marginal when compared to the assembly of any rotation device currently in existence. The costs for assembly of the Mega Susan can further be reduced through mass production. For example, molds may be used for components of the Mega Susan. With these molds, steel plants in most countries where the Mega Susan will be useful may efficiently produce the Mega Susan. Furthermore, the subject matter herein contemplates the use of compatible components and technologies of other than the inventors' design, including technologies that may be licensed or procured from third-party entities to facilitate mass production by plants, etc. The Mega Susan is highly customizable and requires little area or skill to achieve rotation of vehicles otherwise having a very large turn radius. With the Mega Susan, vehicles only need to be driven in a straight line. Accordingly, the Mega Susan is attractive for use in large-scale construction projects. The Mega Susan is also attractive for transportation of equipment and parts and components, in places and lands where funds are scarce and/or the terrain is dotted with intertwining roadways, thus making it impossible to clear swaths wide enough for trucks with long freight to turn corners.

It is contemplated that when executed with the appropriate components, i.e. lightweight steel plates and ultra efficient ball-bearings, as well as other known or foreseeable advanced materials, it is possible and in the future to assemble a Mega Susan which will require few personnel to turn (perhaps even manually) vehicles and loads, i.e. tractor-trailer and freight, of considerable length and weight. Contemplated materials include, among others, adding chrome to steel during the production process to produce ultra-strong steel-chrome alloy compositions having a resulting strength exceeding the strength of typical steel compositions, and carbon fiber materials and alloys similar to or stronger than those used for automobile and aeronautic applications.

Additionally, the method of building by assembly allows for easy assembly and disassembly of the Mega Susan, and further enables easy transportation of a disassembled Mega Susan to alternate locations for storage or re-use.

The Mega Susan as depicted and described herein comprises components suitable or optionally configurable to be suitable for transportation by all known modes, including without limitation by sea, land and air, in standard containers or non-standard containers such as flat rack, platform, flatbed and open-air containers, or on a truck or railcar, etc.

The components of the Mega Susan can also be re-used or recycled. Use of the Mega Susan decreases waste and environmental impact otherwise incurred by alternate known methods for turning vehicles and loads of significant length or weight. Related achievements may be made in reducing fuel and power consumption by affected vehicles, reducing training requirements and special equipment for vehicle operators and reducing effects on operational areas (i.e. space and noise or physical disturbance considerations). The stable and secure methods discussed herein for rotating vehicles and loads of significant size and weight provides increased safety while reducing risk, stress and time to perform associated operations compared to known ‘traditional’ methods. The portability of the Mega Susan eliminates the need for permanent turntable construction (for example if otherwise used for a short-time large-scale project) and facilitates cost-sharing by municipal or local governments, businesses of various sizes and further makes the Mega Susan attractive financially and civically. Accordingly, capacity may be increased and further resource and cost reductions and increased efficiencies may be achieved. The Mega Susan is therefore efficient and environmentally friendly.

### BRIEF DESCRIPTIONS OF DRAWINGS

FIGS. 1A-1H are perspective views of the assembly and use of one embodiment of the Mega Susan.

FIG. 2 is an enlarged perspective view of one embodiment of an assembled Mega Susan.

FIG. 3 is s top-down view of potential turntable positions of the Mega Susan of FIG. 2.

FIG. 4 is a ‘cross-sectional’ view of one embodiment of the Mega Susan, in use.

FIG. 5 is a perspective exploded view of one embodiment of a table of a Mega Susan.

### DETAILED DESCRIPTION

### Example 1

An example method for assembly of a Mega Susan comprises:
(I) Laying out a number of steel plates on a flat surface like a grid;
(II) Placing a fulcrum in the center of the grid of steel plates;
(III) Placing ball-bearings, in the shape of two concentric circles, on the grid of steel plates, about the fulcrum. The ball-bearings may be placed to approximate the position of the wheelbase of the vehicle(s) to be loaded onto the Mega Susan; and
(IV) Placing and connecting steel plates and ramps at each end thereof on the fulcrum.

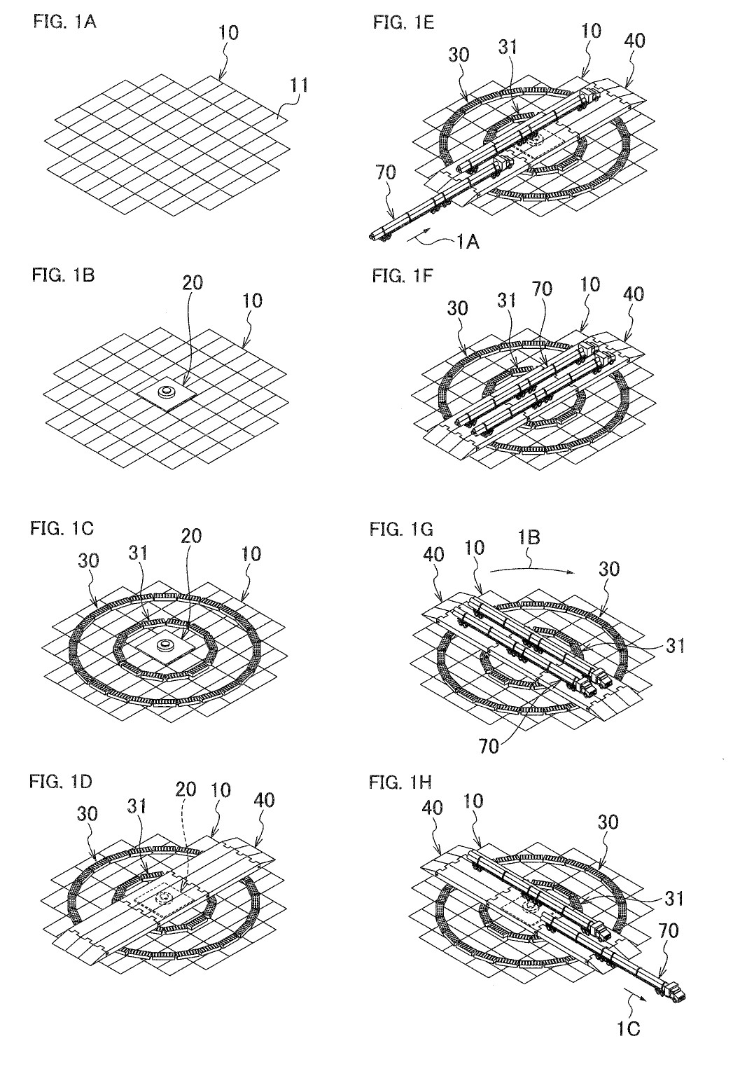

Turning now to the figures, FIGS. 1A-1H show a non-limiting example of a Mega Susan configuration and use.

FIG. 1A illustrates Step I, in which a number of steel plates 11 are laid out on a flat surface like a grid 10. FIG. 1B illustrates Step II, in which a fulcrum 20 of the Mega Susan is placed in the center of the grid 10 of steel plates. In Step III, ball-bearings are placed in two concentric ball-bearing circle sets, 30 and 31, as seen in FIG. 1C. The placement position of the outer ball-bearing circle set 30 approximates the total wheelbase length of the vehicle or truck and trailer/s that the Mega Susan is intended to rotate. Inner ball-bearing circle set 31 is placed at an appropriate distance relative to outer ball-bearing circle set 31. In this manner the Mega Susan is configurable to optimally distribute the weight of the vehicle and load on the ball-bearing circle sets 30 and 31.

FIG. 1D illustrates Step IV, in which a table 40, comprising three connected steel plates having ramps at each end, is placed on top of the fulcrum 20 to complete the Mega Susan.

FIG. 1E illustrates one method of use of the Mega Susan. A first tractor-trailer (with a non-limiting example freight of pipes loaded onto two trailers connected thereto) 70 is driven onto the left side of the table. A second tractor-trailer 70 is driven onto the right side of the table 40, and parked on the platform portion of the table. In this example, both tractor-trailers 70 were driven on from and face the same direction. However, it is contemplated that tractor-trailers 70 face in opposite directions.

As seen in FIG. 1F, two tractor-trailers 70 have been parked on the platform portion of the table 40 such that the first and last wheels of each tractor-trailer 70 sit approximately above the outer ball-bearing circle set 30, i.e. the wheelbase of each tractor-trailer 70 approximately corresponds to the diameter of outer ball-bearing circle set 30.

As depicted in FIG. 1G, the two tractor-trailers 70 are turned using the Mega Susan, in the direction of 1B. For example, the two tractor-trailers may have been turned, from an ‘eastern-facing’ on-loading position, to a ‘southern-facing’ off-loading position. Accordingly, FIG. 1H illustrates one tractor-trailer 70 driving off the steel plate portion of table 40 in the direction 1C while the other tractor-trailer 70 is still parked on the steel plate portion of table 40.

Means or methods for turning the Mega Susan include, among others, the use of gas, steam, hydraulic or natural-powered engine(s)—such as solar or wind-powered engines, manual power—for example using manual labor with or without the assistance of hand cranks or other mechanical systems, animal power—for example the use of cattle, oxen, mule teams, etc., through electromagnetic or magnetic systems, and by hydraulic systems.

### Example 2

The Mega Susan is highly configurable based on the user's needs and location.

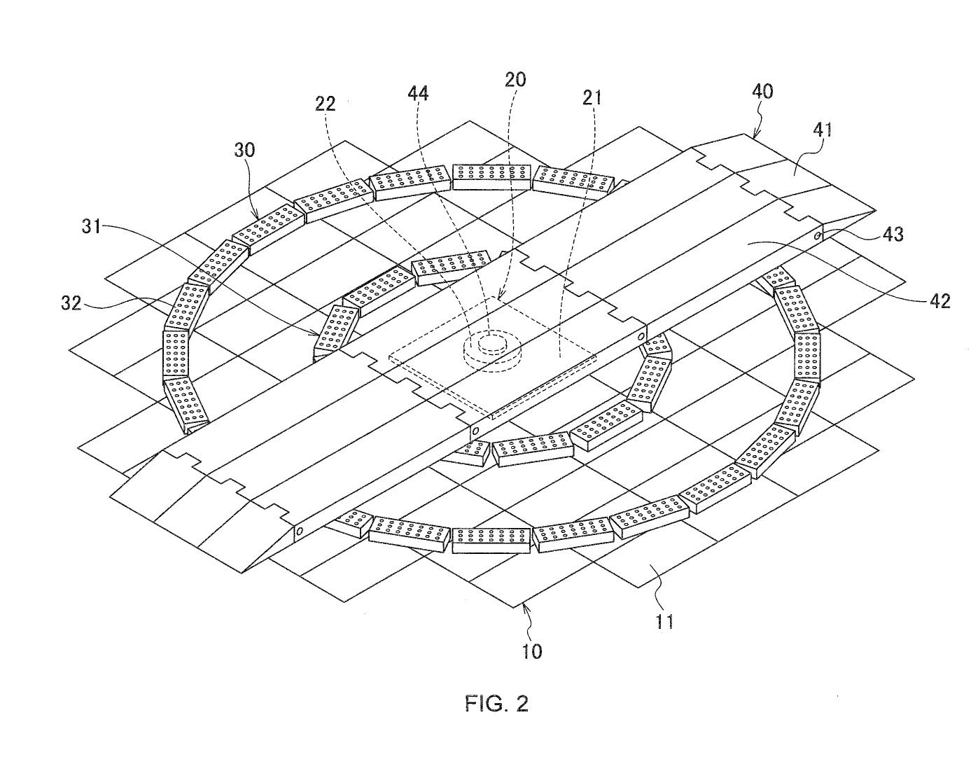

As illustrated in non-limiting FIG. 2, steel plates 11 are laid out in a grid 10. The size, shape and specific material composition of the steel plates 11, as well as the size of the grid 10 may be chosen with a specific use in mind. The general shape of the grid 10 is approximately circular, with the end grid shape affected primarily by the size and shape of the steel plates 11. FIG. 2 shows steel plates 11 of rectangular shape and uniform size; however, in other embodiments, a grid comprising some or all plates of other ‘traditional’ regular or irregular geometric (i.e. rectangular, square, triangular, pentagonal, polygonal, etc.) shapes and non-traditional shapes (i.e. abstract or freeform shapes, geometric shapes having interlocking cut-out pieces, etc.) may be contemplated.

Ball-bearing blocks 32 are arranged in concentric ball-bearing circle sets 31 and 30. The number and placement position of the ball-bearing blocks 32 varies based on the desired size of each ball-bearing circle set, which in turn varies in consideration of the wheelbase of the vehicle(s) to be rotated. For example, ball-bearing circle set 31 is typically sized to correspond with the wheelbase of the vehicle(s) to be rotated.

Table 40 and fulcrum 20 together support vehicle(s) to be rotated. Fulcrum 20 comprises a ball-bearing wheel 22 at the center of the pad 21, and is placed at the center of the ball-bearing circle set 31; in most configurations, this center point is optimally the center of the grid 10.

Table 40 comprises interlocking platform plates 42 connected to one another and to ramp plates 41. A middle platform plate 42 is anchored to a center hollow of the ball-bearing wheel 22, on the fulcrum 21, via recessed hollow 44 (of a center platform plate 42). Pins 43 hold each ramp plate 41 to adjoining platform plates 42 and adjoining platform plates 42 to one another. In this manner the length and width of the table may be configured. Specific sizes, shapes and dimensions of the Mega Susan components, including the plates, ball-bearings, fulcrum(s), table, etc., may be varied and chosen according to the size of the equipment, for example trucks, cranes, construction pipes, to be turned on the resulting assembled Mega Susan.

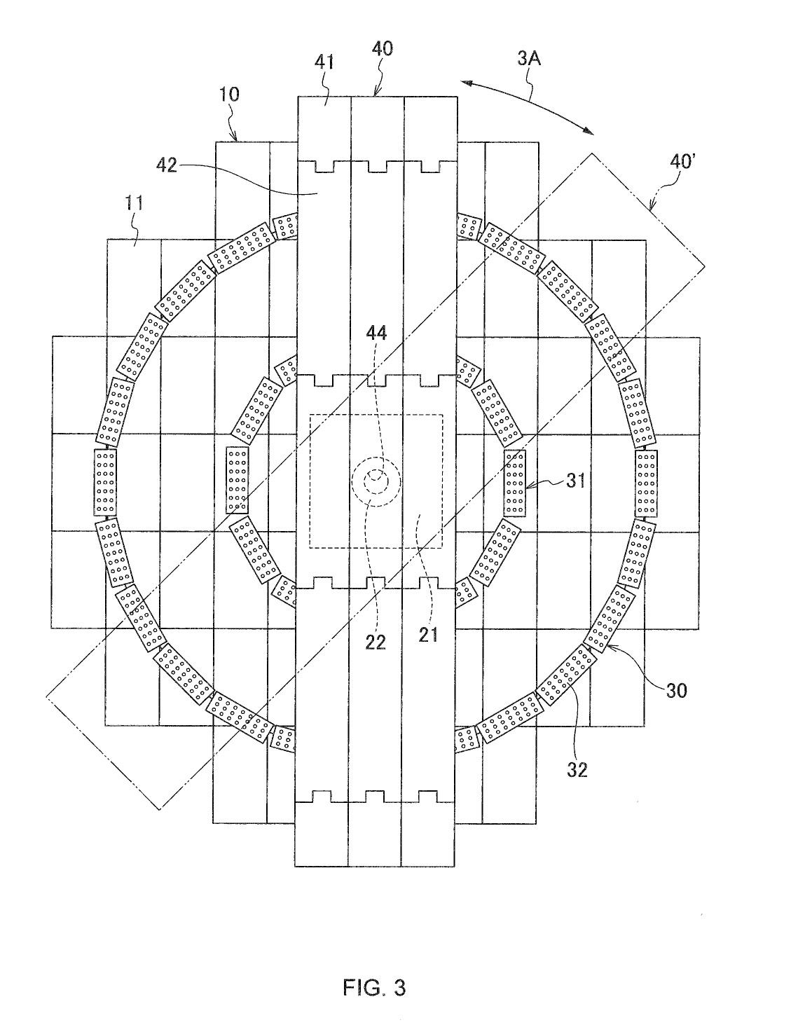

As illustrated in FIG. 3, the assembled Mega Susan may be rotated in the direction of 3A, to the right or left, such that table 40 moves from its initial position, to that indicated by the dashed outline 40.′

### Example 3

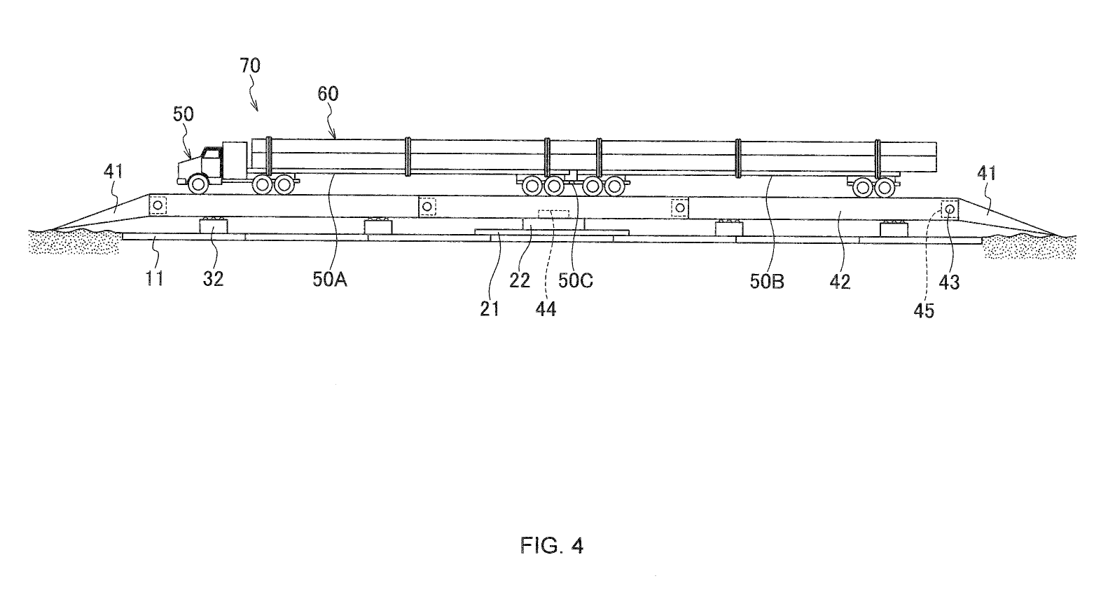

FIG. 4 illustrates one non-limiting embodiment of the Mega Susan, seen in cross-sectional view, in use.

Ball-bearing blocks 32 have been placed on the steel plates 11 of the grid, to form the ball-bearing circle sets that, together with the fulcrum 20, ball-bearing wheel 22 and center plate 44, support the table 40. Connection parts 45 of platform plates 42 and ramp plates 41 are held in place to other platform plates and ramp plates 41 by pin 43. Tractor-trailer 70 comprising tractor 50 and trailers 50A and 50B connected by hitch 50C is parked on table 40. Each of trailers 50A and 50B bear a freight load of pipes 60 which are approximately 90 feet long.

### Example 4

A plurality of adjoined plates may be used to construct a table. For example, a table could be made from four adjoined plates and a ramp on either end of the adjoined plates. In this manner tables of variable size, length and width, may be constructed. Specific sizes, shapes and dimensions of the Mega Susan components, including the plates, ball-bearings, fulcrum(s), table, etc., may be varied and chosen according to the size of the equipment, for example trucks, cranes, construction pipes, to be turned on the resulting assembled Mega Susan.

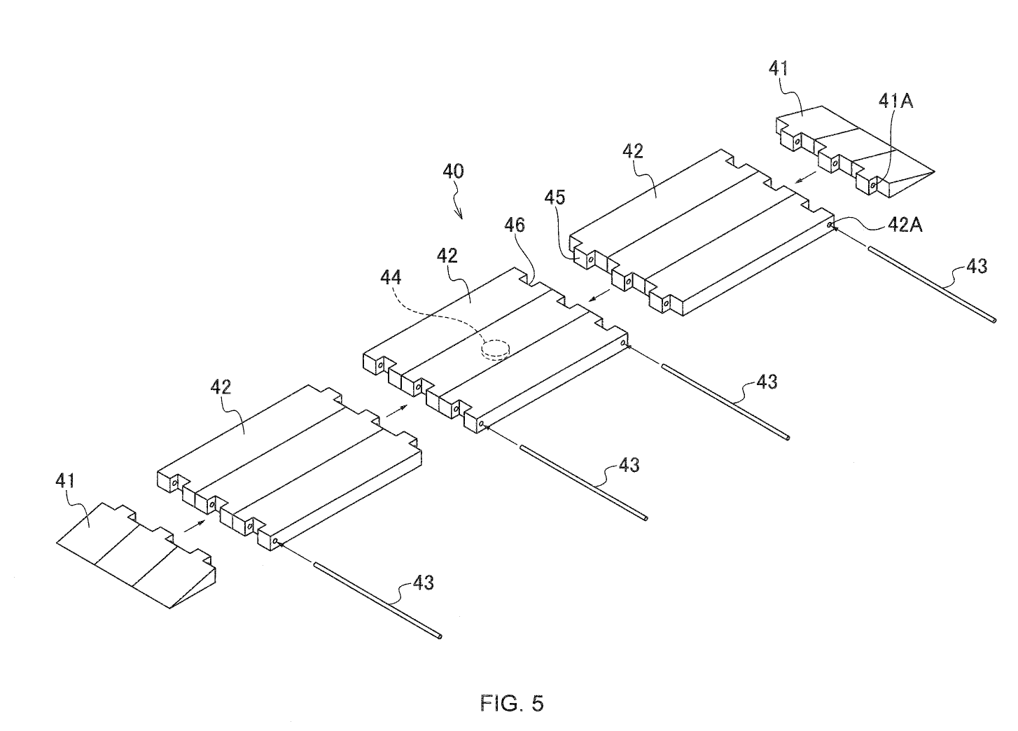

FIG. 5 illustrates a perspective exploded view of one non-limiting embodiment of a table of a Mega Susan. A first ramp plate 41 is connected to a first platform plate 42 by means of male 45 and female 46 connection parts, and is held in place by a pin 43 inserted through holes 41A and 42A of the ramp plate 41 and platform plate 42. The first platform plate 42 is similarly connected to a second platform plate 42, third platform plate 42 and second ramp 41. Although two ramp plates and three platform plates are shown in FIG. 5, any number of plates can be connected to each other to make the table as long or wide as necessary. In the illustrated configuration, center platform plate 42 has only female connection parts 46 and is therefore distinguished from the other platform plates 42, which have both male 45 and female 46 connection parts. Center platform plate 42 is also distinguished by the presence of a recessed hollow 44 (to enable connection of the table 40 to the fulcrum). Pins 43 are inserted into the pinholes 41A and 42A to hold the platform plates 42 to each other and the ramps 41 to the platform plates 42.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It will be understood that many additional changes in the details, materials, steps and arrangement of parts, which have been herein described and illustrated to explain the nature of the subject matter, may be made by those skilled in the art within the principal and scope of the subject matter as expressed in the appended claims.

1. A method of building by assembly a portable turntable or rotation platform, comprising:
laying a number of steel plates on a flat surface;
laying a fulcrum and setting a table or platform thereon; and
laying at least one set of ball-bearings about the fulcrum,
wherein the steel plates are laid out in a grid and the ball-bearings are placed in the shape of two concentric circles.

2. The method of claim 1, wherein the ball-bearings are placed to approximate the position of wheelbase(s) of vehicle(s) to be loaded onto the portable turntable or rotation platform.

3. The method of claim 1, whereby rotation of vehicles and/or loads of significant size and/or weight is achieved.

4. The method of claim 1, further comprising:
placing the fulcrum in the center of the steel plates;
placing ball-bearings on the steel plates, about the fulcrum; and
placing and connecting steel plates and ramps on the fulcrum, at each end thereof

5. The method of claim 4, wherein the ball-bearings are placed in the shape of two concentric circles.

6. The method of claim 4, wherein the ball-bearings are placed to approximate the position of wheelbase(s) of vehicle(s) to be loaded onto the portable turntable or rotation platform.

7. The method of claim 4, whereby rotation of vehicles and/or loads of significant size and/or weight is achieved.

8. A method of rotating vehicles and/or loads of significant size and/or weight, comprising utilizing a number of steel plates laid on a flat surface.

9. The method of claim 8, further comprising laying a fulcrum and setting a table or platform thereon.

10. The method of claim 9, further comprising laying at least one set of ball-bearings about the fulcrum.

11. The method of claim 10, further comprising loading a vehicle and/or load onto the table or platform from a first position, and rotating the table or platform to thereby rotate the vehicle and/or load.

12. A portable turntable or rotation platform built by assembly, comprising a number of steel plates on a flat surface.

13. The portable turntable or rotation platform of claim 12, further comprising a fulcrum and a table or platform thereon.

14. The portable turntable or rotation platform of claim 13, further comprising at least one set of ball-bearings.

15. The portable turntable or rotation platform of claim 12, configured for rotation of vehicles and/or loads of significant size and/or weight.

16. The portable turntable or rotation platform of claim 12, wherein the size, length and width of the portable turntable or rotation platform is fully configurable.

17. The portable turntable or rotation platform of claim 12, wherein the portable turntable or rotation platform is configured to be reusable and/or recyclable.
